(19) United States
(12) Patent Application Publication
(10) Pub. No.: US 2026/0292925 A1
(43) Pub. Date: Sep. 24, 2026

(54) MONITORING WITH DISCONTINUOUS RECEPTION CYCLE

(71) Applicant: Nokia Technologies Oy, Espoo (FI)

(72) Inventors: Chunli WU, Beijing (CN); Jorma Johannes KAIKKONEN, Oulu (FI); Jussi-Pekka KOSKINEN, Oulu (FI)

(21) Appl. No.: 19/473,036

(22) PCT Filed: May 8, 2023
(86) PCT No.: PCT/CN2023/092786

§ 371 Date: Oct. 6, 2025

(51) Int. Cl. H04W 76/28; H04W 52/02

(52) U.S. Cl. CPC H04W 76/28; H04W 52/0235

(57) ABSTRACT

Example embodiments of the present disclosure relate to methods, devices, apparatuses and computer readable storage medium for monitoring with a specific discontinuous reception (DRX) cycle. In a method, a first device capable of a low power-wake up signalling determines that a condition that a DRX cycle specific to the first device is shorter than a threshold is met. Based on the determining, the first device monitors for at least one signal via at least one of a first receiver or a second receiver.

### FIELDS

Various example embodiments of the present disclosure generally relate to the field of telecommunication and in particular, to methods, devices, apparatuses and computer readable storage medium for monitoring with a discontinuous reception (DRX) cycle.

### BACKGROUND

A low power (LP)-wake up signalling (WUS) is being developed for New Radio (NR). One objective is to study and evaluate Layer 1 (L1) procedures and higher-layer protocol changes needed to support a wake up (or wake-up) signal. The study may consider the usage of a separate low power receiver at user equipment (UE) and evaluate how the UE power consumption can be reduced. An intention is that a main radio or a main receiver of the UE, which may be ordinary transceiver, can be in a sleep mode (or even powered off) for power saving and be activated upon reception of the wake-up signal from a network.

However, when the main radio is in an ultra-deep sleep state, the delay for the UE to be able to receive paging from the main radio after the wake-up signal is received on the lower-power receiver may be up to a few hundreds of milliseconds which may be longer than a possible paging cycle. Such latency due to applying of the LP-WUS may be unacceptable.

### SUMMARY

In a first aspect of the present disclosure, there is provided a method at a first device. In the method, the first device capable of a low power-wake up signalling determines that a condition that a DRX cycle specific to the first device is shorter than a threshold is met. Based on the determining, the first device monitors for at least one signal via at least one of a first receiver or a second receiver.

In a second aspect of the present disclosure, there is provided a method at a second device. In the method, the second device determines that a condition that a DRX cycle specific to a first device capable of a low power-wake up signalling is shorter than a threshold is met. Based on the determining, the second device transmits at least one signal to at least one of a first receiver or a second receiver of the first device.

In a third aspect of the present disclosure, there is provided a first device. The first device comprises at least one processor and at least one memory storing instructions that, when executed by the at least one processor, cause the first device at least to determine that a condition that a DRX cycle specific to the first device is shorter than a threshold is met; and based on the determining, monitor for at least one signal via at least one of a first receiver or a second receiver.

In a fourth aspect of the present disclosure, there is provided a second device. The second device comprises at least one processor and at least one memory storing instructions that, when executed by the at least one processor, cause the second device at least to determine that a condition that a DRX cycle specific to a first device capable of a low power-wake up signalling is shorter than a threshold is met; and based on the determining, transmit at least one signal to at least one of a first receiver or a second receiver of the first device.

In a fifth aspect of the present disclosure, there is provided a first apparatus. The first apparatus comprises means for determining that a condition that a DRX cycle specific to a first device capable of a low power-wake up signalling is shorter than a threshold is met; and means for based on the determining, monitoring for at least one signal via at least one of a first receiver or a second receiver.

In a sixth aspect of the present disclosure, there is provided a second apparatus. The second apparatus comprises means for determining that a condition that a DRX cycle specific to a first device capable of a low power-wake up signalling is shorter than a threshold is met; and means for based on the determining, transmitting at least one signal to at least one of a first receiver or a second receiver of the first device.

In a seventh aspect of the present disclosure, there is provided a computer readable medium. The computer readable medium comprises instructions stored thereon for causing an apparatus to perform at least the method according to the first or second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates example state transition of a receiver of a device according to some example embodiments of the present disclosure;

FIG. 3 illustrates a flowchart of a method of monitoring for signals according to some example embodiments of the present disclosure;

FIG. 4 illustrates a flowchart of a method of transmitting signals according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, the LP-WUS is being developed for NR. An intention is that a main radio or receiver of a UE can be in a sleep mode (or even powered off) for power saving and be activated upon the reception of the wake-up signal from a network. For example, the network may trigger the UE to wake up when needed in an event-driven manner, by transmitting to the UE the wake-up signal which may be monitored for by a low power receiver at the UE. When a UE receives the WUS, the low power receiver can trigger the wake-up of a main receiver and communication via the main receiver can start.

In this way, the low power receiver wakes up the main radio, and, otherwise, the main radio is OFF or kept in a deep sleep mode. The low power receiver may be operated in an always “on” manner with very low power consumption. It is expected that the low power receiver will consume less power compared to the ordinary transceiver, by designing simple WUS and the use of a dedicated hardware for its monitoring. In some cases, the low power receiver may be designed to be able to receive only the WUS.

When the main radio is in an ultra-deep sleep state, a ramp-up time of the main radio could up to hundreds of milliseconds. The ramp-up time may comprise a procedure for hardware tune on, for example, boot, memory load and/or the like of the main radio. The total time for the main radio to transit from the ultra-deep sleep state to an active or micro sleep state is the sum of a ramp-up time and a time for synchronization or re-synchronization (or “(re-) re-synchronization time”). The synchronization/re-synchronization time may comprise a procedure for the main radio to (re-)synchronize with a serving gNB.

The delay until the UE is able to receive paging via the main radio after the wake-up signal is received via the lower-power receiver includes the ramping up time as well as the (re-)synchronization time of the main radio which could be up to a few hundreds of milliseconds.

The cell specific paging cycles configured in a system information bock (SIB) may have the following values:

| | |
|---|---|
| PagingCycle ::= | ENUMERATED {rf32, rf64, rf128, rf256} |
| ExtendedPagingCycle-r17 ::= | ENUMERATED {rf256, rf512, rf1224, spare1} |

Besides, the UE may also be configured by a core network (CN) with a UE specific DRX cycle for paging. The shorter one of the UE specific DRX cycle and the cell specific cycle may be used by the UE for monitoring for the paging.

Delay from the reception of the LP-WUS until the main receiver of the UE is ready to monitor downlink (DL), which is introduced by the LP-WUS, may be longer than a possible paging cycle. The network (NW) may consider the potential delay introduced by the LP-WUS when it configures its cell specific DRX cycle for paging if the LP-WUS is enabled in a cell. But it is not possible for the NW to know UE specific DRX cycles that UEs camping on the cell are using and would be paged with until a paging message indicating a UE specific cycle is transmitted from the CN or a serving gNB for an IDLE or INACTIVE mode.

If the CN assigns a short UE specific DRX cycle for a UE, it expects short paging latency. The CN does not necessarily need to know a LP-WUS capability of a UE and whether a LP-WUS is enabled for a cell or not. However, if the UE applies the LP-WUS, it might introduce unacceptable latency.

Example embodiments of the present disclosure propose a scheme of monitoring for signals with a shorter specific DRX cycle. With the scheme, if a LP-WUS capable device (such as a UE) determines that a DRX cycle specific to the device is shorter than a threshold, the device monitors for at least one signal via at least one of a first receiver or a second receiver. In some example embodiments, the first receiver may comprise a lower power receiver, and the second receiver may comprise a main receiver.

The proposed scheme allows behaviors of the LP-WUS capable device configured with a shorter specific DRX cycle to be different from those of a device without a specific DRX cycle or with a specific DRX cycle not shorter than the threshold. In this way, paging delay for a device with a shorter specific DRX cycle may be reduced.

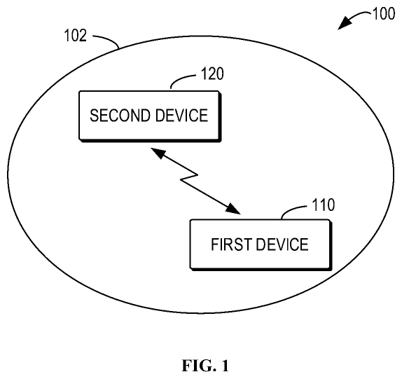

FIG. 1 illustrates an example communication environment 100 in which example embodiments of the present disclosure can be implemented. In the communication environment 100, a plurality of communication devices, comprising a first device 110 and a second device 120, can communicate with each other. In some example embodiments, the first device 110 may operate as a terminal device and the second device 120 may operate as a network device serving the terminal device. The serving area of the second device 120 may be called a cell 122.

It is to be understood that the number of devices and their connections shown in FIG. 1 are only for the purpose of illustration without suggesting any limitation. The communication environment 100 may include any suitable number of devices configured to implement example embodiments of the present disclosure. Although not shown, it would be appreciated that one or more additional devices may be located in the cell 122, and one or more additional cells served by the second device 120 or another device may be deployed in the communication environment 100.

In the following, for the purpose of illustration, some example embodiments are described with the first device 110 operating as a terminal device and the second device 120 operating as a network device. However, in some example embodiments, operations described with respect to a terminal device may be implemented at a network device or other devices, and operations described with respect to a network device may be implemented at a terminal device or other devices.

In some example embodiments, if the first device 110 is a terminal device and the second device 120 is a network device, a link from the second device 120 to the first device 110 is referred to as a DL, while a link from the first device 110 to the second device 120 is referred to as an uplink (UL). In DL, the second device 120 is a transmitting (TX) device (or a transmitter), and the first device 110 is a receiving (RX) device (or a receiver). In UL, the first device 110 is a TX device (or a transmitter), and the second device 120 is a RX device (or a receiver). If both the first device 110 and the second device 120 are terminal devices, a link between two terminal devices is referred to as a sidelink (SL). In SL, one of the first and second devices 110 and 120 is a TX device (or a transmitter), and the other of the first and second devices 110 and 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In various embodiments, the first device 110 is capable of monitoring for a LP-WUS and includes a first receiver and a second receiver. The first receiver may monitor for a low power wake-up signal and may be a low power receiver (such as a simple receiver with an envelope detector). The second receiver may monitor for other signals or channels and may be a main receiver such as an Orthogonal Frequency Division Multiple Access (OFDMA) receiver (such as a receiver with Fast Fourier Transform (FFT) processing and analog-to-digital conversion (ADC) processing). In some cases, the first receiver and the second receiver may be the same receiver or share at least a part. In these cases, the receiver can be operated in a very low power state with a limited reception capability for monitoring for the LP-WUS.

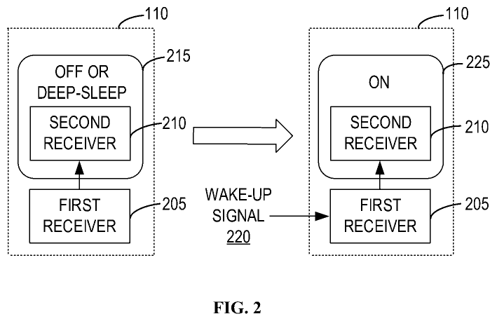

In some example embodiments, the second receiver may be in a sleep, deep-sleep or even OFF state and may be switched to an active or ON state by a wake-up signal received by the first receiver. FIG. 2 shows example state transition of the second receiver of the first device 110 according to some example embodiments of the present disclosure. As shown in FIG. 2, the first device 110 includes a first receiver 205 and a second receiver 210, and the second receiver 210 is first in an OFF or deep-sleep state 215 based on a DRX configuration. The first receiver 205 monitors for a wake-up signal 220 and then triggers the second receiver 210 to switch from the OFF or deep-sleep state 215 to an ON state 225.

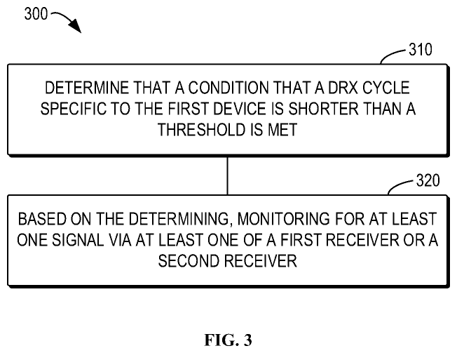

The delay from the reception of the LP-WUS until the second receiver 210 is ready to monitor may be unacceptable if the first device 110 is configured with a shorter DRX cycle for paging. According to some example embodiments of the present disclosure, if the first device 110 determines that a condition that a DRX cycle specific to the first device 110 is shorter than a threshold is met, the first device 110 monitors for at least one signal via at least one of the first receiver 205 or the second receiver 215. Some example implementations at the first device 110 will be described in detail below with reference to FIG. 3.

FIG. 3 shows a flowchart of an example method 300 for monitoring for signals in accordance with some example embodiments of the present disclosure. The method 300 can be implemented by the first device 110. For the purpose of discussion, the method 300 will be described from the perspective of the first device 110 with reference to in FIGS. 1 and 2.

At block 310, the first device 110 determines that a condition that a DRX cycle specific to the first device 110 is shorter than a threshold is met. In some example embodiments, the threshold may be configured, for example, by the NW separately. Alternatively, or in addition, the threshold may comprise a predefined threshold that may be statically specified.

In some example embodiments, the threshold may comprise a cell specific DRX cycle. In an example, the cell specific DRX cycle may be broadcast by the second device 120 in the cell 122. In this example, if the DRX cycle specific to the first device 110 is shorter than a value of the broadcast cell specific CRX, then the first device 110 determines that the condition is met.

In some example embodiments, the threshold may comprise a time period after a signal (such as a LP-WUS) is received via the first receiver 205 and before the second receiver 210 is ready to monitor. In these embodiments, if the condition is met, it means that delay from the reception of the signal via the first receiver 205 until the second receiver 210 is ready to monitor for signals is longer than the DRX cycle configured for paging.

At block 320, based on the determination on the condition, the first device 110 monitors for at least one signal via at least one of the first receiver 205 or the second receiver 210. In some example embodiments, the first device 110 may receive an indication that the LP-WUS is enabled in the cell 122. In the case that the LP-WUS is enabled in the cell 122, the first device 110 may not monitor for the LP-WUS but use the second device 120 to monitor for a signal, which may comprise a paging message, a paging occasion, paging downlink control information (DCI) and/or a paging early indication (PEI), if the DRX cycle specific to the first device 110 is shorter than a threshold. Other devices configured with longer specific DRX cycles or without specific DRX cycles may monitor for the LP-WUS while keeping their main radios in sleep or OFF states.

In an example, in the case that the threshold to compared with the DRX cycle specific to the first device 110 is a time period after a signal is received via the first receiver 205 and before the second receiver 210 is ready to monitor, the first device 110 may not be allowed to monitor for the LP-WUS if the delay is longer than the specific DRX cycle which is configured for paging. In this case, the first device 110 may monitor a PO as in legacy. The first device 110 may be allowed to monitor for the LP-WUS if the delay is shorter than the specific DRX cycle.

In some example embodiments, in the case that both the LP-WUS and the PEI are enabled in the cell 122, if the first device 110 is configured with a specific DRX cycle shorter than a threshold, the first device 110 may apply only PEI, while other LP-WUS and PEI capable devices could apply both.

The DRX cycle specific to the first device 110 may be configured by the network based on latency requirements of the first device 110. For example, if the first device 110 has some low latency services such as ultra-reliable and low latency communications (URLLCs), the first device 110 may be configured by the network with a shorter specific DRX cycle. The monitoring for paging rather than the LP-WUS regardless of whether the first device 110 and/or the NW supports the LP-WUS or whether the LP-WUS is enabled in the cell 122 may avoid the delay caused by transmit of the second receiver 210 from a sleep or OFF state to an ON state. Thus, the communication efficiency may be improved.

In some example embodiments, the first device 110 configured with a shorter specific DRX cycle may monitor for signals via both the first receiver 205 and the second receiver 210 while causing the second receiver 210 to stay awake or wake up quickly. In an example, the second receiver 210 may stay awake so that there is no ramp-up/re-synchronization delay for the second receiver 210. In this example, if a signal such as a wake-up signal is monitored for via the first receiver 205 or the monitored signal triggers the first device 110 to monitor for a further signal via the second receiver 210, the first device 110 may monitor for a further signal such as a PO via the second receiver 210. Due to no ramp-up/re-synchronization delay for the second receiver 210, the communication efficiency may be improved while power consumption may be still saved at the first device 110 since the second receiver 210 does not need to continue monitoring.

In some example embodiments, the second receiver 120 may be caused in a state where a time period after a signal is received via the first receiver 205 and before the second receiver 210 is ready to monitor is shorter than a threshold time period. The threshold time period may be set to be shorter than a normal delay from reception of the signal via the first receiver 205 until the second receiver 210 is ready to monitor. In these embodiments, the second receiver 210 may not be switched to an ultra-deep-sleep state with a ramp-up time in hundreds of milliseconds. A shorter ramp-up time or re-synchronization time may be defined for this state. In this way, the second receiver 120 may wake up quickly for monitoring for a PO, and thus the communication delay may be reduced.

In some example embodiments, the first device 110 may receive a configuration for at least one of a ramp-up or a re-synchronization time of the second receiver 220 which may be shorter than a normal ramp-up or re-synchronization time. The first device 110 may cause the second receiver 220 to wake up based on the configuration. Thus, the delay due to the ramp-up time or a re-synchronization time may be reduced.

In some example embodiments, the first device 110 configured with a shorter specific DRX cycle may keep the second receiver 210 ON in a longer time period than a device configured with a longer specific DRX cycle or without a specific DRX cycle. Thus, the delay due to transition of the second receiver 210 from a sleep mode to an ON state may be reduced, thereby improving the communication efficiency.

In some embodiments, the condition that the first device 110 considers to determine whether the first receiver 205 and/or the second receiver 210 are used for monitoring may comprise a condition that at least one of an emergency service or a low latency service is ongoing. In an example, if the first device 110 has an ongoing emergency call or other low latency services, the first device 110 may cause the second receiver 210 to stay awake or wake up quickly as described above to reduce the communication delay.

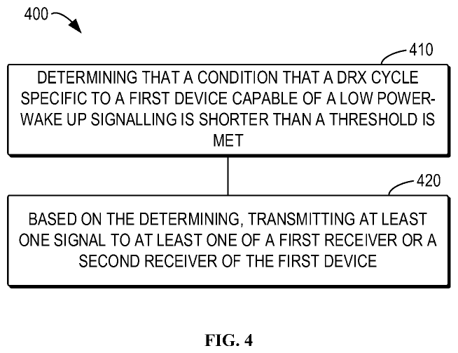

FIG. 4 shows a flowchart of an example method 400 of transmitting signals in accordance with some example embodiments of the present disclosure. The method 400 can be implemented at the second device 120. For the purpose of discussion, the method 400 will be described from the perspective of the second device 120 with reference to FIGS. 1 and 2.

At block 410, the second device 120 determines that a condition that a DRX cycle specific to the first device 110, which is capable of a low power-wake up signalling, is shorter than a threshold is met. At block 420, based on the determining, the second device 120 transmits at least one signal to at least one of the first receiver 205 or the second receiver 210 of the first device 110.

In some example embodiments, the threshold comprises at least one of: a cell specific discontinuous reception cycle, a time period after a signal is received via the first receiver of the first device and before the second receiver of the first device is ready to monitor, a configured threshold, or a predefined threshold.

In some example embodiments, the second device 120 may transmit an indication that the low power-wake up signalling is enabled in the cell 122.

In some example embodiments, the second device 120 may transmit a signal to the second receiver 210 of the first device 110 configured with a shorter specific DRX cycle without transmitting the low power-wake up signal. In some example embodiments, the signal to the second receiver 210 of the first device 110 may comprise at least one of paging DCI, a paging message, or a PEI.

In some example embodiments, the second device 120 may transmit a signal to the first receiver 205 of the first device 110 and then transmit a further signal to the second receiver 210 of the first device 110, based on the second receiver of the first device staying awake.

In some example embodiments, based on the second receiver 210 of the first devicec 110 being in a state where a time period after a signal is received via the first receiver 205 of the first device 110 and before the second receiver 210 of the first device 110 is ready to monitor is shorter than a threshold time period, the second device 120 may transmit at least one of the signal to the first receiver 205 of the first device 110 and the further signal to the second receiver 210 of the first device 110.

In some example embodiments, the second device 120 may transmit, to the first device 110, a configuration for at least one of a ramp-up time or a re-synchronization time of the second receiver 210 of the first device 110. Based on the configuration, the second device 120 may transmit at least one of the signal to the first receiver 205 of the first device 110 and the further signal to the second receiver 210 of the first device 110.

### Example Apparatus, Device and Medium

In some example embodiments, a first apparatus capable of performing the method 300 (for example, the first device 110 in FIG. 1) may comprise means for performing the respective operations of the method 300. The means may be implemented in any suitable form. For example, the means may be implemented in a circuitry or software module. The first apparatus may be implemented as or included in the first device 110 in FIG. 1.

In some example embodiments, the first apparatus comprises means for determining that a condition that a discontinuous reception cycle specific to a first device capable of a low power-wake up signalling is shorter than a threshold is met; and means for based on the determining, monitoring for at least one signal via at least one of a first receiver or a second receiver.

In some example embodiments, the first receiver comprises a low power receiver, and the second receiver comprises a main receiver.

In some example embodiments, at least a part of the first receiver is shared by the second receiver.

In some example embodiments, the threshold comprises at least one of: a cell specific discontinuous reception cycle, a time period after a signal is received via the first receiver and before the second receiver is ready to monitor, a configured threshold, or a predefined threshold.

In some example embodiments, the first apparatus further comprises means for receiving an indication that the low power-wake up signalling is enabled in a cell.

In some example embodiments, the means for monitoring for the at least one signal comprises: means for monitoring for a signal via the second receiver without monitoring for the low power-wake up signal.

In some example embodiments, the signal monitored for via the second receiver comprises at least one of paging downlink control information, a paging message, or a paging early indication.

In some example embodiments, the means for monitoring for the at least one signal comprises: means for monitoring for a signal via the first receiver; and means for in response to a signal being monitored via the first receiver, monitoring for a further signal via the second receiver.

In some example embodiments, the first apparatus further comprises means for causing, based on the determining, the second receiver to stay awake.

In some example embodiments, the first apparatus further comprises means for causing, based on the determining, the second receiver to be in a state, wherein a time period after a signal is received via the first receiver and before the second receiver is ready to monitor is shorter than a threshold time period in the state.

In some example embodiments, the first apparatus further comprises means for receiving a configuration for at least one of a ramp-up time or a re-synchronization time of the second receiver; and means for causing the second receiver to wake up based on the configuration.

In some example embodiments, the first apparatus further comprises means for performing other operations in some example embodiments of the method 300 or the first device 110. In some example embodiments, the means comprises at least one processor; and at least one memory storing instructions that, when executed by the at least one processor, cause the performance of the first apparatus.

In some example embodiments, a second apparatus capable of performing the method 400 (for example, the second device 120 in FIG. 1) may comprise means for performing the respective operations of the method 400. The means may be implemented in any suitable form. For example, the means may be implemented in a circuitry or software module. The second apparatus may be implemented as or included in the second device 120 in FIG. 1.

In some example embodiments, the second apparatus comprises means for determining that a condition that a discontinuous reception cycle specific to a first device capable of a low power-wake up signalling is shorter than a threshold is met; and means for based on the determining, transmitting at least one signal to at least one of a first receiver or a second receiver of the first device.

In some example embodiments, the first receiver comprises a low power receiver, and the second receiver comprises a main receiver.

In some example embodiments, the threshold comprises at least one of: a cell specific discontinuous reception cycle, a time period after a signal is received via the first receiver of the first device and before the second receiver of the first device is ready to monitor, a configured threshold, or a predefined threshold.

In some example embodiments, the second apparatus further comprises: means for transmitting an indication that the low power-wake up signalling is enabled in a cell.

In some example embodiments, the means for transmitting the at least one signal comprises: means for transmitting a signal to the second receiver of the first device without transmitting the low power-wake up signal.

In some example embodiments, the signal to the second receiver of the first device comprises at least one of paging downlink control information, a paging message, or a paging early indication.

In some example embodiments, the means for transmitting the at least one signal comprises: means for transmitting a signal to the first receiver of the first device; and means for transmitting a further signal to the second receiver of the first device.

In some example embodiments, at least one of the signal to the first receiver of the first device and the further signal to the second receiver of the first device is transmitted based on the second receiver of the first device staying awake.

In some example embodiments, at least one of the signal to the first receiver of the first device and the further signal to the second receiver of the first device is transmitted based on the second receiver of the first device being in a state, wherein a time period after a signal is received via the first receiver of the first device and before the second receiver of the first device is ready to monitor is shorter than a threshold time period in the state.

In some example embodiments, the second apparatus further comprises: means for transmitting, to the first device, a configuration for at least one of a ramp-up time or a re-synchronization time of the second receiver of the first device, wherein at least one of the signal to the first receiver of the first device and the further signal to the second receiver of the first device is transmitted based on the configuration.

In some example embodiments, the second apparatus further comprises means for performing other operations in some example embodiments of the method 400 or the second device 120. In some example embodiments, the means comprises at least one processor; and at least one memory storing instructions that, when executed by the at least one processor, cause the performance of the second apparatus.

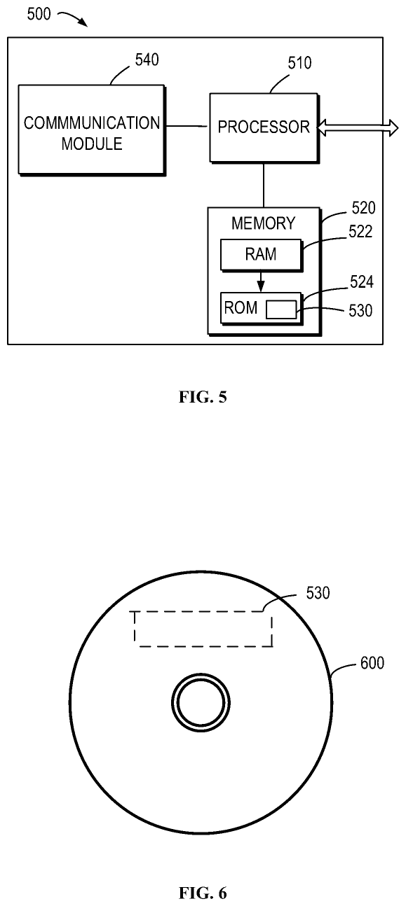

FIG. 5 is a simplified block diagram of a device 500 that is suitable for implementing example embodiments of the present disclosure. The device 500 may be provided to implement a communication device, for example, the first device 110 or the second device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524.

The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 1 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server. In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-15. (canceled)

16. An apparatus configured with low power-wake up signalling and operates in an idle or inactive mode of a cellular communication network, wherein the apparatus comprises:
a low power receiver;
a main receiver;
a processor; and
a memory comprising computer-executable instructions that, when executed by the processor, cause the apparatus to perform the following operations:
determining that a condition that a discontinuous reception cycle specific to the apparatus is shorter than a threshold is met, wherein the threshold comprises a time period after reception of a low power wake-up signal via the low power receiver and before the main receiver is ready to monitor paging; and
based on the determining, monitoring for a paging signal via the main receiver without monitoring for the low power wake-up signal via the low power receiver, wherein the paging signal comprises at least one of paging downlink control information, a paging message, or a paging early indication.

17. The apparatus claim 16, wherein at least a part of the low power receiver is shared by the main receiver.

18. The apparatus of claim 17, wherein the threshold comprises the time period after a signal is received via the low power receiver and before the main receiver is ready to monitor.

19. The apparatus of claim 18, wherein the computer-executable instructions that, when executed by the processor, further cause the apparatus to perform the following operations:
receiving an indication that the low power-wake up signalling is enabled in a cell.

20. The apparatus of claim 16, wherein the computer-executable instructions that, when executed by the processor, further cause the apparatus to perform the following operations:
causing, based on the determining, the main receiver to stay awake.

21. The apparatus of claim 20, wherein the computer-executable instructions that, when executed by the processor, further cause the apparatus to perform the following operations:
causing, based on the determining, the main receiver to be in a state, wherein a time period after a signal is received via the low power receiver and before the main receiver is ready to monitor is shorter than a threshold time period in the state.

22. The apparatus of claim 21, wherein the computer-executable instructions that, when executed by the processor, further cause the apparatus to perform the following operations:
receiving a configuration for at least one of a ramp-up time or a re-synchronization time of the main receiver; and
causing the main receiver to wake up based on the configuration.

23. The apparatus of claim 22, wherein determining that the discontinuous reception cycle specific to the apparatus is shorter than the threshold comprises comparing the discontinuous reception cycle specific to the apparatus with a cell-specific discontinuous reception cycle broadcast by a network device.

24. The apparatus of claim 23, wherein the apparatus is configured with a shorter discontinuous reception cycle based on a latency requirement associated with at least one low-latency service or emergency service.

25. The apparatus of claim 24, wherein the monitoring for the paging signal via the main receiver is performed while maintaining the main receiver in an active state for a duration longer than a duration used by a device configured with a longer discontinuous reception cycle.

26. A method performed by an apparatus that operates in an idle or inactive mode of a cellular communication network, the apparatus configured with low power-wake up signalling and comprising a low power receiver and a main receiver, wherein the method comprises:
determining that a condition that a discontinuous reception cycle specific to the apparatus is shorter than a threshold is met, wherein the threshold comprises a time period after reception of a low power wake-up signal via the low power receiver and before the main receiver is ready to monitor paging; and
based on the determining, monitoring for a paging signal via the main receiver without monitoring for the low power wake-up signal via the low power receiver, wherein the paging signal comprises at least one of paging downlink control information, a paging message, or a paging early indication.

27. The method of claim 26, wherein at least a part of the low power receiver is shared by the main receiver.

28. The method of claim 27, wherein the threshold comprises the time period after a signal is received via the low power receiver and before the main receiver is ready to monitor.

29. The method of claim 28, further comprising:
receiving an indication that the low power-wake up signalling is enabled in a cell.

30. The method of claim 26, further comprising:
causing, based on the determining, the main receiver to stay awake.

31. The method of claim 30, further comprising:
causing, based on the determining, the main receiver to be in a state, wherein a time period after a signal is received via the low power receiver and before the main receiver is ready to monitor is shorter than a threshold time period in the state.

32. The method of claim 31, further comprising:
receiving a configuration for at least one of a ramp-up time or a re-synchronization time of the main receiver; and
causing the main receiver to wake up based on the configuration.

33. The method of claim 32, wherein determining that the discontinuous reception cycle specific to the apparatus is shorter than the threshold comprises comparing the discontinuous reception cycle specific to the apparatus with a cell-specific discontinuous reception cycle broadcast by a network device.

34. The method of claim 33, wherein the apparatus is configured with a shorter discontinuous reception cycle based on a latency requirement associated with at least one low-latency service or emergency service.

35. The method of claim 34, wherein the monitoring for the paging signal via the main receiver is performed while maintaining the second receiver in an active state for a duration longer than a duration used by a device configured with a longer discontinuous reception cycle.
